(19) United States
(12) Patent Application Publication
(10) Pub. No.: US 2025/0026265 A1
(43) Pub. Date: Jan. 23, 2025

(54) COLLISION AVOIDANCE SYSTEM AND METHOD

(71) Applicant: HYUNDAI MOBIS CO., LTD., Seoul (KR)

(72) Inventors: Ji Hong Kim, Gwangmyeong-si (KR); Chang Ik Lee, Suwon-si (KR); Soo Bong Lee, Yongin-si (KR)

(73) Assignee: HYUNDAI MOBIS CO., LTD., Seoul (KR)

(21) Appl. No.: 18/668,977

(22) Filed: May 20, 2024

(30) Foreign Application Priority Data
Jul. 17, 2023 (KR) 10-2023-0092381

(51) Int. Cl. B60Q 9/00

(52) U.S. Cl. CPC B60Q 9/008

(57) ABSTRACT

A system for avoiding a collision between a vehicle and a neighboring object includes a plurality of lamps installed in the vehicle and irradiating light to respective divided areas around the vehicle, a speed measurement sensor measuring a speed of the vehicle, a distance measurement sensor measuring a relative distance between the vehicle and the neighboring object, and a controller determining a collision risk area between the vehicle and the neighboring object from among the divided areas based on the measured speed and relative distance, and controlling a lamp irradiating light to the collision risk area. The system may prevent a collision between the vehicle and the neighboring object by providing a notification through control of the plurality of lamps irradiating light to the respective divided areas around the vehicle.

### CROSS-REFERENCE TO RELATED APPLICATION(S)

This application claims the benefit of Korean Patent Application No. 10-2023-0092381, filed on Jul. 17, 2023, which is hereby incorporated by reference as if fully set forth herein.

### BACKGROUND

### 1. Field

The disclosure relates to a collision avoidance system and method which may prevent a collision between a vehicle and a neighboring object by providing a notification through control of a plurality of lamps that emit light to respective divided areas around the vehicle.

### 2. Description of Related Art

Conventionally, various safety techniques for preventing vehicle accidents have focused on minimizing the loss of life in the event of an accident.

In addition, conventional techniques for determining the possibility of a collision between a vehicle and a neighboring object are mainly based on using ultrasonic sensors, radars, video cameras, and other sensors to obtain the distance between the vehicle and the neighboring object, and when the distance is within a certain range, warn of the danger of a collision or apply the brake to prevent a collision or reduce damage.

However, these techniques require the vehicle to be equipped with multiple sensors and a device for processing signals transmitted between the multiple sensors. The use of the multiple sensors and the device may increase power consumption, cost, and the failure rate of a system.

Moreover, since the above-described techniques for determining the possibility of a collision are limited to determining the possibility of a collision with a neighboring object ahead of the vehicle in the direction of travel of the vehicle, it is difficult to determine the possibility of a collision with a neighboring object approaching from the side or rear of the vehicle.

In particular, since the techniques for determining the possibility of a collision described above focus on providing information only to the driver of the vehicle, there is a problem in that they are not capable of warning and allowing neighboring objects, including pedestrians, to be aware of the risk of a collision in advance.

Therefore, there is a need for a means for preventing a collision between a vehicle and a neighboring object in advance while solving the problems described above.

### SUMMARY

The disclosure is intended to provide a collision avoidance system and method. More specifically, the disclosure is intended to provide a collision avoidance system and method, which may prevent a collision between a vehicle and a neighboring object by providing a notification through control of a plurality of lamps that emit light to respective divided areas around the vehicle.

In addition, the disclosure is intended to provide a collision avoidance system and method, which may classify collision risk levels, based on vehicle speeds and relative distances to neighboring objects, and provide visual or auditory notifications according to the classified collision risk levels.

The problems to be solved by the disclosure are not limited to the technical problems mentioned above, and other technical problems not mentioned will be clearly understood by those skilled in the art from the following description below.

A system for avoiding a collision between a vehicle and a neighboring object is provided, including a plurality of lamps configured to be installed in the vehicle and to irradiate light to respective divided areas around the vehicle, a speed measurement sensor measuring a speed of the vehicle, a distance measurement sensor measuring a relative distance between the vehicle and the neighboring object, and a controller determining a collision risk area between the vehicle and the neighboring object from among the divided areas based on the measured speed and relative distance, and controlling, among the plurality of lamps, a lamp irradiating light to the collision risk area.

The controller may determine a collision risk distance between the vehicle and the neighboring object according to a braking distance of the vehicle, and then t may identify a collision risk level by comparing the measured relative distance with the determined collision risk distance.

The collision risk level may include a safety level, a caution level, and a danger level, and the controller may control the lamp according to the identified collision risk level.

The controller may control the lamp by changing a color of light irradiated by the lamp.

The system may further include an audio output unit configured to be installed in the vehicle and to provide a notification, and the controller may control the audio output unit to change a number of times a notification is provided according to the identified collision risk level.

The system may further include an internal lighting configured to be installed in the vehicle, and the controller may control the internal lighting to change at least one of a color of light from the internal lighting or a number of times the internal lighting is turned on according to the identified collision risk level.

Each divided area irradiated by light ahead of and behind the vehicle has a width that may be greater than a width of a divided area irradiated by light on a side of the vehicle.

The distance measurement sensor may include medium range radars (MMRs) configured to be installed at a front and a rear of the vehicle, and a short range radar (SRR) configured to be installed on a side of the vehicle.

A method of avoiding a collision between a vehicle and a neighboring object is provided, including radiating, by a plurality of lamps installed in the vehicle, light to respective divided areas around the vehicle, measuring, by a speed measurement sensor, a speed of the vehicle, measuring, by a distance measurement sensor, a relative distance between the vehicle and the neighboring object, and determining, by a controller, a collision risk area between the vehicle and the neighboring object from among the divided areas based on the measured speed and relative distance, and controlling, by the controller, among the plurality of lamps, a lamp radiating light to the collision risk area.

The controlling of the lamp may include, after determining, by the controller, a collision risk distance between the vehicle and the neighboring object according to a braking distance of the vehicle, identifying, by the controller, a collision risk level by comparing, by the controller, the measured relative distance with the determined collision risk distance, and changing, by the controller, a color of light irradiated by the lamp according to the identified collision risk level.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram illustrating a vehicle according to an embodiment of the disclosure;

FIG. 2 is a side view illustrating a cross-section taken along line A-A of FIG. 1;

FIG. 3 is a block diagram illustrating a collision avoidance system according to an embodiment of the disclosure;

FIGS. 4 and 5 are diagrams illustrating areas irradiated by light around a vehicle in a collision avoidance system according to an embodiment of the disclosure;

FIG. 6 is a diagram illustrating collision risk areas between a vehicle and neighboring objects in a collision avoidance system according to an embodiment of the disclosure;

FIG. 7 is a diagram illustrating a collision avoidance method according to an embodiment of the disclosure; and

FIG. 8 is a detailed diagram illustrating a lamp control method in a collision avoidance method according to an embodiment of the disclosure.

### DETAILED DESCRIPTION

Description will now be given in detail according to exemplary embodiments disclosed herein, with reference to the accompanying drawings. The same or equivalent components may be provided with the same reference numbers, and description thereof will not be repeated. As used herein, the suffixes “module” and “part” are added or used interchangeably to facilitate preparation of this specification and are not intended to suggest distinct meanings or functions. In describing embodiments disclosed in this specification, relevant well-known technologies may not be described in detail in order not to obscure the subject matter of the embodiments disclosed in this specification. In addition, it should be noted that the accompanying drawings are only for easy understanding of the embodiments disclosed in the present specification, and should not be construed as limiting the technical spirit disclosed in the present specification. As such, the disclosure should be construed to extend to any alterations, equivalents and substitutes in addition to those which are particularly set out in the accompanying drawings.

Although the terms first, second, etc. may be used herein to describe various elements, these elements should not be limited by these terms. These terms are generally only used to distinguish one element from another.

It will be understood that when an element is referred to as being “connected with” another element, the element can be directly connected with the other element or intervening elements may also be present. In contrast, it will be understood that when an element is referred to as being “directly connected with” another element, there are no intervening elements present.

A singular representation may include a plural representation unless it represents a definitely different meaning from the context.

The terms such as “include” or “have” used herein are intended to indicate that features, numbers, steps, operations, elements, components, or combinations thereof used in the following description exist and it should be thus understood that the possibility of existence or addition of one or more different features, numbers, steps, operations, elements, components, or combinations thereof is not excluded.

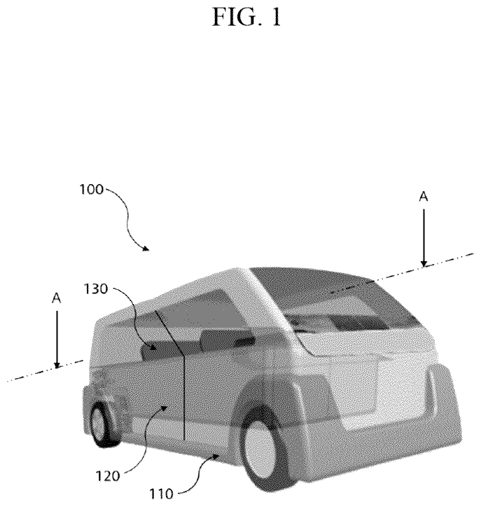

FIG. 1 is a diagram illustrating a vehicle 100 according to an embodiment of the disclosure.

The vehicle 100 of the disclosure may include any vehicle, and in one aspect, a purpose built vehicle (PBV) which may provide various convenience structures to occupants.

Referring to FIG. 1, the vehicle 100 may include a skateboard 110, a cabin 120, and a seat 130 located within the cabin 120.

The skateboard 110 forms the bottom surface of a vehicle body. Additionally, the cabin 120 may be coupled to the top of the skateboard 110 and provide a riding space and a separate storage space.

For example, because the floor of the cabin 120 is low, the seat 130 should be adjusted high to a position where a visibility line is secured for a clear view of a driver. Therefore, a separate storage space may be secured at a bottom portion of the seat 130 installed in a boarding space of the cabin 120.

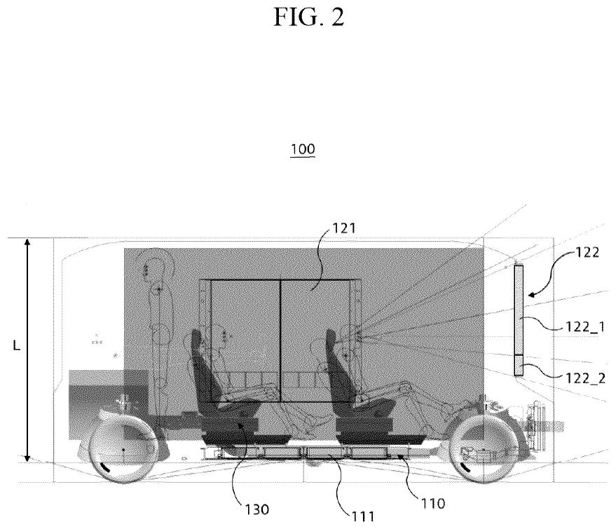

FIG. 2 is a side view illustrating a cross-section taken along line A-A of FIG. 1.

Referring to FIG. 2, a battery mounting space 111 may be provided in the skateboard 110. The battery mounting space 111 is preferably designed in consideration of installation of a battery (not shown) and control precision.

For the convenience of occupants, the cabin 120 preferably allows rotation of the seat 130 as well as recline adjustment of the seat 130. In particular, a total height L of the cabin 120 may be designed to a height where the occupants may stand comfortably.

Herein, the total height L of the cabin 120 may be adjusted by separate control.

A side display 121 installed in the cabin 120 may transmit an entertainment screen for infotainment and other information images on a screen.

A windshield 122 may have a display form that selectively displays an image inside and outside the vehicle. The windshield 122 may include an electrochromic image area 122_1 and an opaque image area 122_2.

The electrochromic image area 122_1 may adjust shading so that an image is selectively displayed to the inside or outside of the vehicle, upon power-on. The opaque image area 122_2 may extend to the bottom or top of the electrochromic image area 122_1.

In another example, the windshield 122 may be divided into an internal display area and an external display area. For example, the internal display area may display an image toward the inside of the vehicle, and the external display area may display an image toward the outside of the vehicle. The internal display area and the external display area may have separate electrical application paths.

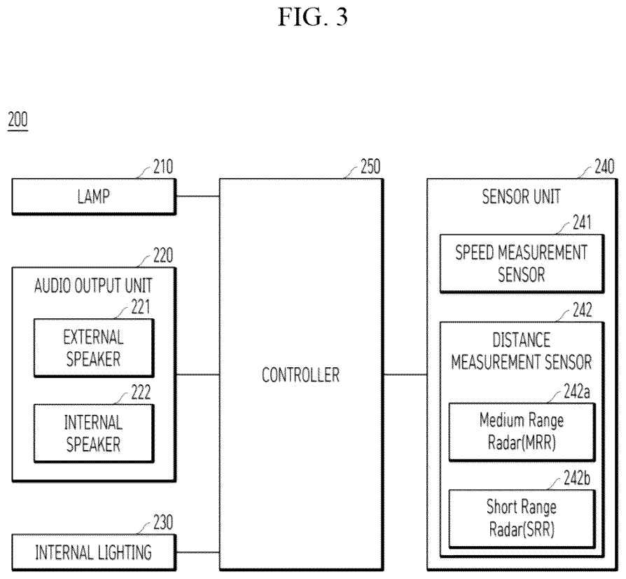

FIG. 3 is a block diagram illustrating a collision avoidance system 200 according to an embodiment of the disclosure.

The collision avoidance system 200 according to an embodiment of the disclosure may include a lamp 210, an audio output unit 220, an internal lighting 230, a sensor unit 240, and a controller 250.

The lamp 210 may be installed in the vehicle 100 illustrated in FIGS. 1 and 2 and irradiate light around the vehicle 100. The audio output unit 220 may include an external speaker 221 installed outside the vehicle 100 and an internal speaker 222 installed inside the vehicle 100. Further, the internal lighting 230 may be installed inside the vehicle 100.

The collision avoidance system 200 according to an embodiment of the disclosure may provide a visual or auditory notification for preventing a collision between the vehicle 100 and a neighboring object through the lamp 210, the audio output unit 220, or the internal lighting 230, which will be described later in more detail.

The sensor unit 240 may be located in the vehicle 100 and collect real-time driving information about the vehicle 100. For example, the sensor unit 240 may include an acceleration sensor, a brake sensor, a tilt sensor, a yaw/pitch/roll sensor, a steering angle sensor, and a global positioning system (GPS) sensor. The real-time driving information about the vehicle 100, such as straight driving, turning driving, a change in speed, a change in acceleration, and a change in vehicle height, may be collected through the sensor unit 240.

Particularly, the sensor unit 240 may include a speed measurement sensor 241 and a distance measurement sensor 242 in the collision avoidance system 200 according to an embodiment of the disclosure. The speed measurement sensor 241 may measure the speed of the vehicle 100, and the distance measurement sensor 242 may measure a relative distance between the vehicle 100 and a neighboring object. Further, the speed measurement sensor 241 may measure the speed of the neighboring object based on a change in the speed of the vehicle 100 and the relative distance to the neighboring object.

The distance measurement sensor 242 may include a medium range radar (MRR) 242a and a short range radar (SRR) 242b. Referring to FIG. 1, MRRs 242a may be installed at the front and rear of the vehicle 100, and SRRs 242b may be installed on the sides of the vehicle 100.

The controller 250 may be one or more computers configured to perform the disclosed operations or actions by virtue of having software, firmware, hardware, or a combination of them installed that in operation causes or cause the controller 250 to perform the actions.

The controller 250 may control the lamp 210, the audio output unit 220, and the internal lighting 230, based on the speed of the vehicle 100 measured through the speed measurement sensor 241 and the relative distance between the vehicle 100 and the neighboring object measured through the distance measurement sensor 242.

Therefore, a visual or auditory notification may be provided to prevent a collision between the vehicle 100 and the neighboring object, which may be described later in more detail.

The block diagram of the collision avoidance system 200 illustrated in FIG. 3 is only for an embodiment of the disclosure, and each component of the block diagram may be integrated or omitted, or other components may be added, according to the specifications of the collision avoidance system 200 which is actually implemented. That is, as needed, two or more components may be combined into one component, or one component may be subdivided into two or more components. Further, functions performed in each block are for describing embodiments of the disclosure, and specific operations or devices thereof do not limit the scope of the disclosure.

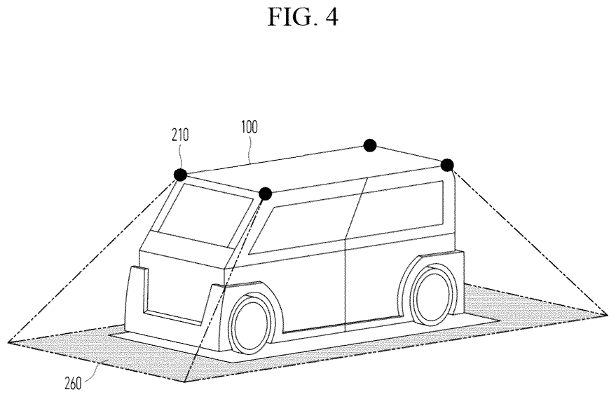

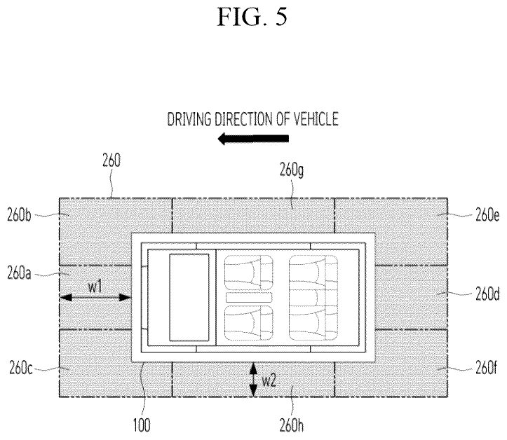

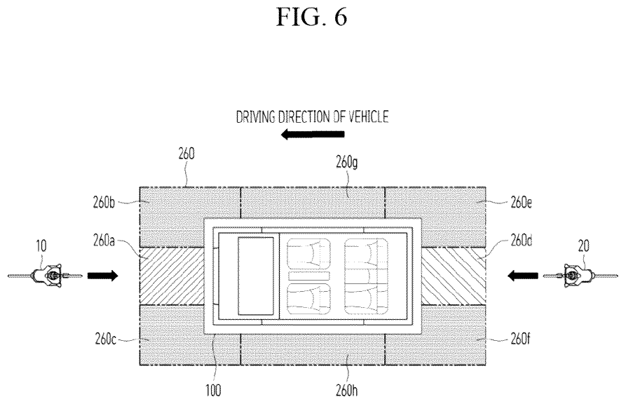

FIGS. 4 and 5 are diagrams illustrating areas 260 irradiated by light around the vehicle 100 in the collision avoidance system 200 according to an embodiment of the disclosure. FIG. 6 is a diagram illustrating collision risk areas between the vehicle 100 and neighboring objects 10 and 20 in the collision avoidance system 200 according to an embodiment of the disclosure.

The collision avoidance system 200 according to an embodiment of the disclosure may be installed in the vehicle 100 and include a plurality of lamps 210 that irradiate light around the vehicle 100. Accordingly, the plurality of lamps 210 may be installed along the perimeter of the vehicle 100 to irradiate light from the top of the vehicle 100 toward a road surface. Additionally, the plurality of lamps 210 may irradiate light to respective divided areas 260a, 260b, 260c, 260d, 260e, 260f, 260g, and 260h around the vehicle 100.

That is, the collision avoidance system 200 according to an embodiment of the disclosure may form an area 260 irradiated by light without blind spots around the vehicle 100 by irradiating light to the respective divided areas 260a, 260b, 260c, 260d, 260e, 260f, 260g, and 260h around the vehicle 100 through the plurality of lamps 210.

FIG. 4 is a diagram illustrating the area 260 irradiated by light around the vehicle 100 through the plurality of lamps 210 installed in the vehicle 100 according to an embodiment of the disclosure. FIG. 5 is a diagram illustrating division of the area 260 irradiated by light according to an embodiment of the disclosure.

Referring to FIGS. 4 and 5 together, the collision avoidance system 200 according to an embodiment of the disclosure may provide a visual notification to a neighboring object approaching the vehicle through the plurality of lamps 210 that irradiate light to the respective divided areas 260a, 260b, 260c, 260d, 260e, 260f, 260g, and 260h around the vehicle 100.

More specifically, referring to FIGS. 3 and 6 together, in the collision avoidance system 200 according to an embodiment of the disclosure, the controller 250 may determine collision risk areas between the vehicle 100 and the neighboring objects 10 and 20 from among the divided areas 260a, 260b, 260c, 260d, 260e, 260f, 260g, and 260h, and control lamps 210 that irradiate light to the collision risk areas, based on the speed of the vehicle 100 measured through the speed measurement sensor 241 and relative distances between the vehicle 100 and the neighboring objects 10 and 20 measured through the distance measurement sensor 242.

Particularly, in the collision avoidance system 200 according to an embodiment of the disclosure, the controller 250 may determine collision risk distances between the vehicle 100 and the neighboring objects 10 and 20 according to a braking distance of the vehicle 100 through the sensor unit 240 including the speed measurement sensor 241 and the distance measurement sensor 242. Collision risk levels may be identified by comparing the measured relative distances between the vehicle 100 and the neighboring objects 10 and 20 with the determined collision risk distances.

The collision risk levels may include a safety level, a caution level, and a danger level, and the controller 250 may control the lamps 210 according to the identified collision risk levels. Additionally, the controller 250 may control the lamps 210 to change the color of light irradiated from the lamps 210.

Referring to FIGS. 4 and 5 together, as the vehicle 100 starts driving, the area 260 irradiated by light around the vehicle 100 may be formed by irradiating light from the plurality of lamps 210. In an embodiment, when there is no risk of a collision with a neighboring object approaching the vehicle 100, this may correspond to the safety level among the above-described collision risk levels, and the plurality of lamps 210 may irradiate green light.

The width of the area 260 irradiated by light may be determined in consideration of the speed and braking distance of the vehicle 100. Further, because the braking distance of the vehicle 100 may vary with the state of the road surface, the state of the road surface on which the vehicle 100 travels may also be considered.

Considering the driving direction and speed of the vehicle 100 in addition to the braking distance of the vehicle 100, the width w1 of the area 260 irradiated by light ahead of or behind the vehicle 100 may be greater than the width w2 of the area 260 irradiated by light on a side of the vehicle 100.

In addition, the collision avoidance system 200 according to an embodiment of the disclosure may measure the speed of a neighboring object through a change in the relative distance to the neighboring object, as described above, thereby taking into account the braking distance of the neighboring object.

For example, referring to FIGS. 5 and 6 together, the braking distance may be 1 m, when the speed of the vehicle 100 is 10 km/h, and about 2 m, when the speed of a bicycle, which is the neighboring object 10 or 20, is 15 km/h.

In this case, the width w1 of the area 260 irradiated by light ahead of or behind the vehicle 100 may be 3 m, and the width w2 of the area 260 irradiated by light on the side of the vehicle 100 may be 1 m.

When the speed of the object 20 approaching the vehicle 100 is equal to or less than 15 km/h, this may correspond to the caution level among the collision risk levels, and the controller 250 described above with reference to FIG. 3 may control a lamp 210 that radiates light to a collision risk area 260d among the divided areas 260b, 260c, 260d, 260e, 260f, 260g, and 260h. In an embodiment, the controller 250 may control the lamp 210 to change the color of light to yellow.

When the speed of the object 10 approaching the vehicle 100 is greater than 15 km/h, this may correspond to the danger level among the collision risk levels, and the controller 250 described above with reference to FIG. 3 may control a lamp 210 that radiates light to a collision risk area 260a among the divided areas 260b, 260c, 260d, 260e, 260f, 260g, and 260h. In an embodiment, the controller 250 may control the lamp 210 to change the color of light to red.

In this manner, the collision avoidance system 200 according to an embodiment of the disclosure may prevent collisions between the vehicle 100 and the neighboring objects 10 and 20 by providing visual notifications to the neighboring objects 10 and 20.

As described above with reference to FIG. 3, the collision avoidance system 200 according to an embodiment of the disclosure may further include the audio output unit 220 installed in the vehicle 100 to provide a notification, and the controller 250 may control the audio output unit 220 such that the number of provided notifications is changed depending on a collision risk level.

For example, no notification may be provided separately at the safety level, and notifications may be provided at intervals of 3 seconds at the caution level and at intervals of 1 second at the danger level.

In addition, as described above with reference to FIG. 3, the collision avoidance system 200 according to an embodiment of the disclosure may further include the internal lighting 230 installed in the vehicle 100, and the controller 250 may control the internal lighting 230 such that at least one of the color of light from the internal lighting 230 or the number of times the internal lighting 230 is turned on varies depending on a collision risk level.

For example, the color of light from the internal lighting 230 may be green at the safety level, yellow at the caution level, and red at the danger level.

That is, the collision avoidance system 200 according to an embodiment of the disclosure may prevent collisions between the vehicle 100 and the neighboring objects 10 and 20 in advance by providing visual or auditory notifications to the neighboring objects 10 and 20 as well as the occupants of the vehicle through the plurality of lamps 210, the audio output unit 220, and the internal lighting 230 installed in the vehicle 100.

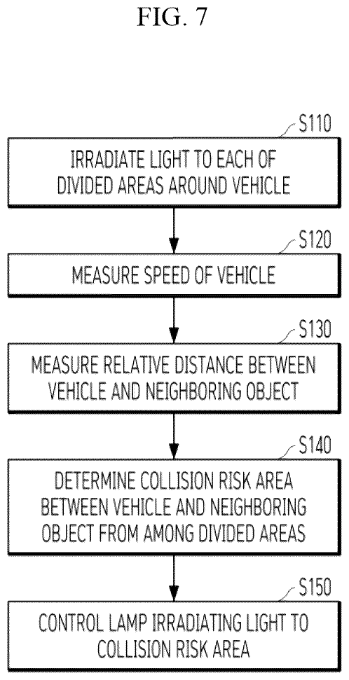

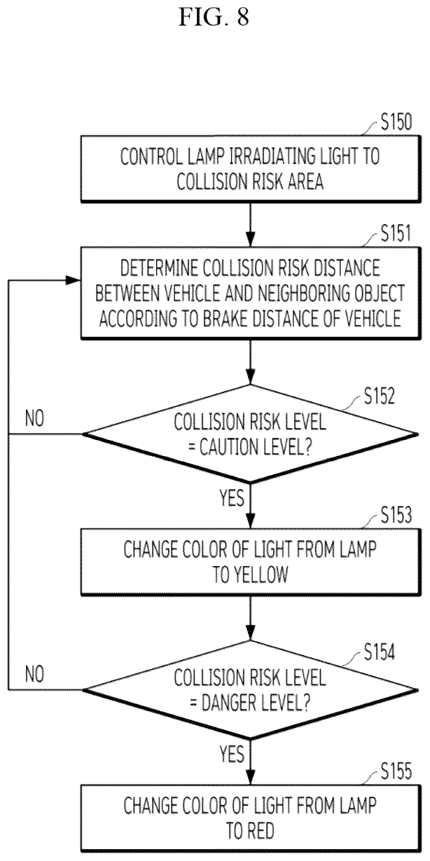

FIG. 7 is a diagram illustrating a collision avoidance method according to an embodiment of the disclosure. FIG. 8 is a detailed diagram illustrating a method of controlling the lamps 210 in the collision avoidance method according to an embodiment of the disclosure. The following description will be given in conjunction with the descriptions of FIGS. 1 to 6 in a comprehensive manner.

In the collision avoidance method according to an embodiment of the disclosure, light may be irradiated to the divided areas 260a, 260b, 260c, 260d, 260e, 260f, 260g, and 260h around the vehicle 100 through the plurality of lamps 210 installed in the vehicle 100 (S110). The speed of the vehicle 100 may be measured through the speed measurement sensor 241 (S120), and a relative distance between the vehicle 100 and a neighboring object may be measured through the distance measurement sensor 242 (S130).

Subsequently, a collision risk area between the vehicle 100 and the neighboring object may be determined from among the divided areas 260a, 260b, 260c, 260d, 260e, 260f, 260g, and 260h based on the measured speed and relative distance (S140), and a lamp 210 that irradiates light to the collision risk area may be controlled (S150).

Controlling the lamp 210 by irradiating light to the collision risk area (S150) may include determining a collision risk distance between the vehicle 100 and the neighboring object according to a braking distance of the vehicle 100, identifying a collision risk level by comparing the measured relative distance with the determined collision risk distance, and changing the color of light emitted from the lamp 210 according to the identified collision risk level. Herein, collision risk levels may include the safety level, the caution level, and the danger level, as described above.

More specifically, referring to FIG. 8, the collision risk distance between the vehicle 100 and the neighboring object may be determined according to the braking distance of the vehicle 100 (S151), and it may be identified whether the collision risk level is the caution level (S152). When the collision risk level is the caution level, the color of light from the lamp 210 may be changed to yellow (S153), and when the collision risk level is not the caution level, the procedure may return to the operation of determining a collision risk distance. It may be determined whether the collision risk level is the danger level (S154), and when the collision risk level is the danger level, the color of light from the lamp 210 may be changed to red (S155).

Further, the collision avoidance method according to an embodiment of the disclosure may provide a visual or auditory notification to the neighboring object as well as the occupants of the vehicle 100 by also controlling the audio output unit 220 and the internal lighting 230, as described above with reference to FIGS. 1 to 6.

In summary, the collision avoidance system and method according to the disclosure may prevent a collision between a vehicle and a neighboring object by providing a notification through control of a plurality of lamps that irradiate light to respective divided areas around the vehicle. In addition, collision risk levels may be classified based on vehicle speeds and relative distances to neighboring objects, and visual or auditory notifications may be provided according to the classified collision risk levels.

The above detailed description is to be construed in all aspects as illustrative and not restrictive. The scope of the disclosure should be determined by reasonable interpretation of the appended claims and all changes coming within the equivalency range of the disclosure are intended to be embraced in the scope of the disclosure.

What is claimed is:

1. A system for avoiding a collision between a vehicle and a neighboring object, comprising:
a plurality of lamps configured to be installed in the vehicle and to irradiate light to respective divided areas around the vehicle;
a speed measurement sensor measuring a speed of the vehicle;
a distance measurement sensor measuring a relative distance between the vehicle and the neighboring object; and
a controller determining a collision risk area between the vehicle and the neighboring object from among the divided areas based on the measured speed and relative distance, and controlling, among the plurality of lamps, a lamp irradiating light to the collision risk area.

2. The system of claim 1, wherein the controller determines a collision risk distance between the vehicle and the neighboring object according to a braking distance of the vehicle, and then identifies a collision risk level by comparing the measured relative distance with the determined collision risk distance.

3. The system of claim 2, wherein the collision risk level includes a safety level, a caution level, and a danger level, and
wherein the controller controls the lamp according to the identified collision risk level.

4. The system of claim 3, wherein the controller controls the lamp by changing a color of light irradiated by the lamp.

5. The system of claim 3, further comprising an audio output unit configured to be installed in the vehicle and to provide a notification,
wherein the controller controls the audio output unit to change a number of times a notification is provided according to the identified collision risk level.

6. The system of claim 3, further comprising an internal lighting configured to be installed in the vehicle,
wherein the controller controls the internal lighting to change at least one of a color of light from the internal lighting or a number of times the internal lighting is turned on according to the identified collision risk level.

7. The system of claim 1, wherein each divided area irradiated by light ahead of and behind the vehicle has a width that is greater than a width of a divided area irradiated by light on a side of the vehicle.

8. The system of claim 1, wherein the distance measurement sensor includes medium range radars (MMRs) configured to be installed at a front and a rear of the vehicle, and a short range radar (SRR) configured to be installed on a side of the vehicle.

9. A method of avoiding a collision between a vehicle and a neighboring object, the method comprising:
radiating, by a plurality of lamps installed in the vehicle, light to respective divided areas around the vehicle;
measuring, by a speed measurement sensor, a speed of the vehicle;
measuring, by a distance measurement sensor, a relative distance between the vehicle and the neighboring object; and
determining, by a controller, a collision risk area between the vehicle and the neighboring object from among the divided areas based on the measured speed and relative distance, and controlling, by the controller, among the plurality of lamps, a lamp radiating light to the collision risk area.

10. The method of claim 9, wherein the controlling of the lamp comprises, after determining, by the controller, a collision risk distance between the vehicle and the neighboring object according to a braking distance of the vehicle, identifying, by the controller, a collision risk level by comparing, by the controller, the measured relative distance with the determined collision risk distance, and changing, by the controller, a color of light irradiated by the lamp according to the identified collision risk level.
